(19) United States
(12) Patent Application Publication
(10) Pub. No.: US 2020/0382534 A1
(43) Pub. Date: Dec. 3, 2020

(54) VISUALIZATIONS REPRESENTING POINTS CORRESPONDING TO EVENTS

(71) Applicant: ENTIT SOFTWARE LLC, Sanford, NC (US)

(72) Inventors: Andrey Simanovsky, Sunnyvale, CA (US); Manish Marwah, Palo Alto, CA (US)

(21) Appl. No.: 16/426,856

(22) Filed: May 30, 2019

(51) Int. Cl. H04L 29/06

(52) U.S. Cl. CPC H04L 63/1425

(57) ABSTRACT

In some examples, a system computes risk scores relating to points corresponding to events in a computing environment, using a plurality of different risk score computation techniques, and generates a plurality of visualizations representing the points. The plurality of visualizations include a first visualization representing the points and including the risk scores computed using a first risk score computation technique of the different risk score computation techniques, and a second visualization representing the points and including the risk scores computed using a second risk score computation technique of the different risk score computation techniques.

### BACKGROUND

A computing environment can include a network of computers and other types of devices. Issues can arise in the computing environment due to behaviors of various entities. Monitoring can be performed to detect such issues, and to take action to address the issues.

### BRIEF DESCRIPTION OF THE DRAWINGS

Some implementations of the present disclosure are described with respect to the following figures.

FIG. 1 is a block diagram of an arrangement including a score visualization engine according to some examples.

FIGS. 2-7 are graphs of different visualizations including scatter plots according to some examples.

FIG. 8 is a block diagram of a storage medium storing machine-readable instructions according to some examples.

FIG. 9 is a block diagram of a system according to some examples.

FIG. 10 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Certain events (or collections of events) due to behaviors of entities in a computing environment can be considered anomalous. Examples of entities can include users, machines (physical machines or virtual machines), programs, sites, network addresses, network ports, domain names, organizations, geographical jurisdictions (e.g., countries, states, cities, etc.), or any other identifiable element that can exhibit a behavior including actions in the computing environment. A behavior of an entity can cause an anomalous event if the behavior deviates from an expected rule, criterion, threshold, policy, past behavior of the entity, behavior of other entities, or any other target, which can be predefined or dynamically set.

An example of an anomalous behavior of a user involves the user making greater than a number of login attempts into a computer within a specified time interval, or a number of failed login attempts by the user within a specified time interval. An example of an anomalous behavior of a machine or program (e.g., an application program, an operating system, a firmware, a malware, etc.) involves the machine or program receiving or sending greater than a threshold number of data packets (such as due to a port scan or a denial-of-service attack) within a specified time interval, or a number of login attempts by users on the machine that exceed a threshold within a specified time interval. Another example of an anomalous behavior includes exfiltration, which involves the unauthorized transfer or copying of data from a network or machine to a destination outside the network or machine.

To identify issues due to anomalous behavior in a computing environment (e.g., a network, a machine, a collection of machines, a program, a collection of programs, etc.), information of activities (in the form of data packets, requests and responses, etc.) can be analyzed. Issues due to anomalous behaviors can be referred to as “anomalies,” which can include any or some combination of: a security attack of a system, a threat that can cause an error, reduced performance of a machine or program (or a collection of machines or programs), stolen or other unauthorized access of information, and so forth.

An activity or a collection of activities can be referred to as an “event.” Some events may correspond to an anomaly, while other events may not be considered anomalous. For each event, a number of features can be collected, where a “number of features” can refer to one feature or to multiple features. A “feature” can refer to any attribute that is representative of an aspect associated with an event. Examples of features can include any or some combination of: a user name, a program name, a network address, a metric relating to a usage or performance of a machine or program, a metric relating to an action of an entity (such as a user, machine, or program), and so forth.

Anomaly detectors can be used to produce anomaly scores for respective events or entities (or more specifically, for respective collections of a number of features). An “anomaly score” refers to a value that indicates a degree of anomalousness of an event or entity. For example, the anomaly score can include a probability that a given event or entity is anomalous.

In some cases, risk scores can be assigned to events or entities. As used here, a risk score can refer to a measure of risk that an event or entity can present to a computing environment if the event or entity were exhibiting anomalous behavior. A risk to a computing environment can refer to damage, error, loss, or any other compromise of the computing environment or a portion of the computing environment.

A risk score can be computed based on a combination of an anomaly score and impact score. An impact score represents an impact, where an impact can refer to an effect that an event or entity would have on a computing environment if the event or entity were to exhibit anomalous behavior. For example, a user in a sensitive role (e.g., an executive officer of a company, a chief information technology officer of the company, etc.) if compromised would have a larger impact on the computing environment than another user whose role is less sensitive (such as a user who takes customer service calls). As another example, an anomalous event occurring on a machine belonging to a user with greater privileges (e.g., a network administrator) may have a larger impact on the computing environment than an anomalous event occurring on a machine belonging to a user with less privileges. The effect that an event or entity can have on a computing environment can refer to issues, problems, or other adverse consequences that may be caused by the event or entity if exhibiting anomalous behavior.

When there are a large number of events or entities, risk scores computed for the events or entities can be used to filter events or entities based on a risk score threshold. For example, only events or entities with the top k (k 1) risk scores may be considered for further processing. This creates a competition between three categories of events or entities for a spot in the top k list. The three categories include: 1) moderately anomalous scores with moderate impact; 2) highly anomalous events with low impact; and 3) somewhat anomalous events with high impact. The competition between the three categories of events or entities can result in events or entities from one category masking events or entities from another category, which can complicate risk analysis and may cause security risks to be overlooked.

In accordance with some implementations, techniques or mechanisms are provided that do not filter events or entities based on comparing risk scores to a risk score threshold, but rather, produces visualizations of events or entities based on the risk scores computed using respective different risk score computation techniques. An analyst can switch between the different visualizations corresponding to the different risk score computation techniques to perform risk analysis of events or entities.

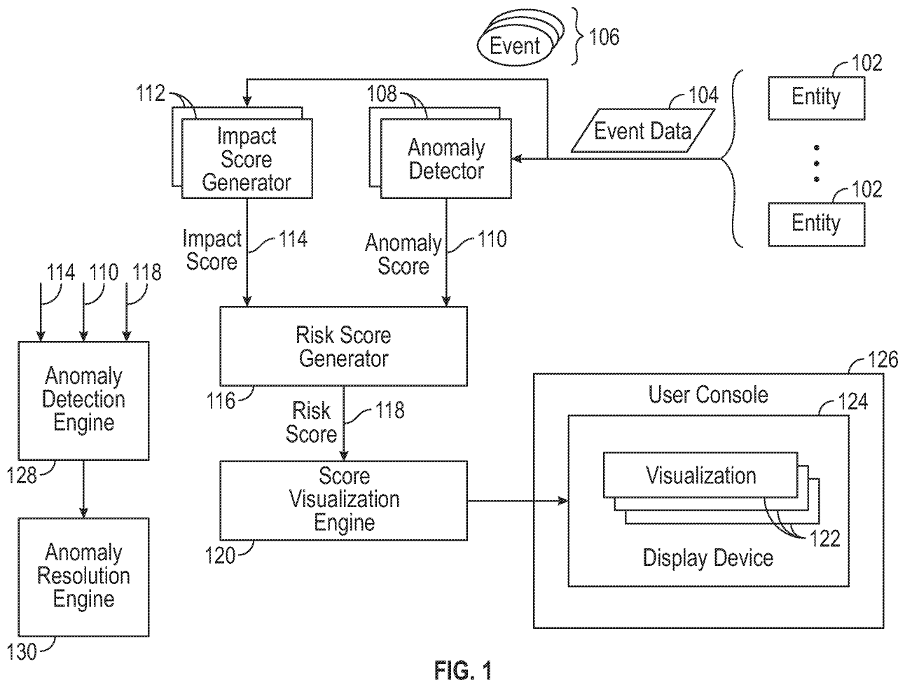

FIG. 1 is a block diagram of an example computing environment that includes a number of entities 102, including users, machines, and/or programs (a program includes machine-readable instructions). Activities of the entities 102 produce raw event data 104 that represent events 106 that have occurred in the computing environment.

Examples of events can include any or some combination of the following: login events (e.g., events relating to a number of login attempts and/or devices logged into); events relating to access of resources such as websites, files, machines, programs, etc.; events relating to submission of queries such as Domain Name System (DNS) queries; events relating to sizes and/or locations of data (e.g., files) accessed; events relating to loading of programs; events relating to execution of programs; events relating to accesses made of components of the computing environment; errors reported by machines or programs; events relating to performance monitoring or measurement of various characteristics of the computing environment (including monitoring of network communication speeds, execution speeds of programs, etc.), and/or other events.

Data relating to events can be collected as event data records (also referred to as “data points” or simply “points”), which are part of the event data 104. An event data record (or “point”) can include a number of features, such as a time feature (to indicate when the event occurred or when the event data record was created or modified). Further features of an event data record can depend on the type of event that the event data record represents. For example, if an event data record is to represent a login event, then the event data record can include a time feature to indicate when the login occurred, a user identification feature to identify the user making the login attempt, a resource identification feature to identify a resource in which the login attempt was made, and so forth. For other types of events, an event data record can include other features.

The event data 104 can include any or some combination of the following types of data: network event data, host event data, application data, and so forth. Network event data is collected on a network device such as a router, a switch, or other network device that is used to transfer or otherwise communicate data between other devices. Examples of network event data include Hypertext Transfer Protocol (HTTP) data, DNS data, Netflow data (which is data collected according to the Netflow protocol), and so forth.

Host event data can include data collected on computers (e.g., desktop computers, notebook computers, tablet computers, server computers, etc.), smartphones, Internet-of-Things (IoT) devices, or other types of electronic devices. Host event data can include information of processes, files, operating systems, and so forth, collected in computers.

Application data can include data produced by application programs, such as logs of the activities of a Web server or DNS server or other application programs such as database programs, spreadsheet programs, word processing programs, program development and monitoring tools, and so forth.

The computing environment also includes an anomaly detector or multiple anomaly detectors 108. An anomaly detector 108 is able to produce an anomaly score 110 based on a number of features that are part of a point (also referred to as “an event data record” above). An anomaly detector 108 receives an event data record that is part of the event data 104, and generates a corresponding anomaly score 110, which is a raw anomaly score. For multiple event data records representing respective different events 106, the anomaly detector 108 produces respective anomaly scores 110.

In examples with multiple anomaly detectors 108, the anomaly detectors 108 can be different types of anomaly detectors that apply different anomaly detection techniques. In such examples, for each event data record, the multiple anomaly detectors 108 generate respective anomaly scores 110 based on the event data record. The scores from multiple anomaly detectors can be aggregated to produce a single score.

The computing environment also includes an impact score generator 112, which produces an impact score 114 for each event data record. In other examples, there can be multiple impact score generators 112.

The impact score generator 112 can determine an impact score based on a context of an event or entity, where the context can include a static context and/or a dynamic context. In some examples, the impact score generator 112 can determine multiple impact scores based on the respective static and dynamic context of the entity.

Although the present description refers to impact scores for both static and dynamic contexts, it is noted that in other examples, an impact score can be produced for just a static context or a dynamic context.

The impact score generator 112 computes a static impact score based on the static context of a given event or entity. The static impact score can be computed based on the static attributes of the static context using any of a number of different techniques. For example, a domain expert, such as an analyst or any other person with special knowledge or training regarding impacts of different attributes of an even or entity on a computing environment, may assign a static impact score to each static attribute, and possibly, a weight for the static attribute. The static impact score can be a weighted average of the analyst assigned scores (assigned to the respective static attributes), where the weighted average can be produced by the impact score generator 112 (by averaging values each produced based on a product of a respective static impact score and the respective weight). A different technique involves learning (such as by a classifier) the static impact scores and weights from historical data collected from one enterprise or from an entire industry.

The impact score generator 112 can further determine a dynamic impact score based on a dynamic context for the given event or entity. As noted above, dynamic attributes of the dynamic contexts of an entity can change for different settings. For example, a user can have access to different information at different times based on the user's involvement in different projects. Alternatively, a user may be travelling and presenting to a customer, in which case compromising the user's account may have a severe impact on the enterprise.

The dynamic impact score can be computed as a weighted average of dynamic impact scores assigned to the respective dynamic attributes. The dynamic impact scores and weights can be assigned by domain experts or can be learnt from historical data.

In some examples, the impact score generator 112 can compute an overall impact score that can be a weighted combination (e.g., weighted sum or other mathematical aggregate) of the static impact score and the dynamic impact score. In the absence of any weights assigned to the static and dynamic impact scores, the overall impact score can be an average (or some other mathematical aggregate) of the static and dynamic impact scores. Alternatively, weights can be assigned to the respective static and dynamic impact scores, where the weights can be assigned by domain experts or can be learnt (by a classifier) from historical data collected over time.

The impact score 114 produced by the impact score generator 112 for each event or entity can be the overall impact score, a static impact score, or a dynamic impact score.

The anomaly scores 110 and the impact scores 114 are input into a risk score generator 116. The risk score generator 116 computes a risk score 118 by combining the anomaly score 110 and the impact score 114, as discussed further below.

In some examples, it can be assumed that the anomaly detector 108 generates anomaly scores in a range between 0 to 1 (or in another range in other examples). In case of anomaly scores having a different range, a normalization, such as negative exponentiation in case of arbitrary non-negative scores, can be applied as follows:

N=e^{-U}, (Eq. 1)

where U represents a raw anomaly score 110, and N represents a normalized anomaly score.

In other examples, if arbitrary anomaly scores of both signs are used, sigmoid or scaled hyperbolic tangent can be applied to the raw anomaly scores U as in Eqs. 2 and 3, respectively:

$$\begin{matrix}{N}_{1} = \frac{1}{1 + {e}^{- U}} , & ( Eq . 2 ) \\ {N}_{2} = \frac{1}{2} ( 1 + tanh U ) , & ( Eq . 3 )\end{matrix}$$

It is assumed that impact scores 114 for events are also normalized within the 0 to 1 range (or another range in another example). Similar transformations (negative exponentiation, sigmoid, and scaled hyperbolic tangent as in Eqs. 1, 2, and 3, respectively) can be applied to the impact scores 114 to produce respective normalized impact scores.

There can be multiple ways to combine an anomaly score and an impact score to produce a risk score. In some examples, three different techniques for computing risk scores by the risk score generator 116 are discussed below.

In other examples, other techniques for computing risk scores can be used.

According to a first risk score computation technique, the risk score generator 116 computes a risk score Rₜ by taking the product of an anomaly score (e.g., a normalized anomaly score) and an impact score (e.g., a normalized impact score), according to Eq. 4:

Rₜ=N*I, (Eq. 4)

where N stands for anomaly score, I stands for impact score, and Rₜ stands for risk score.

According to a second risk score computation technique (also referred to as a “conservative risk score computation technique”), the risk score generator 116 computes a risk score R_{c} based on a harmonic mean of a reverse of the anomaly score (N) and impact score (I):

$${R}_{c} = 1 - \frac{2}{\frac{1}{1 - N} + \frac{1}{1 - I}} , \qquad ( Eq . 5 )$$

A third risk score computation technique (referred to as a “hybrid risk score computation technique) uses a combination of the first and second risk score computation techniques. As provided in Eq. 6 below, the risk score generator 116 computes a risk score Rₕ that is equal to Rₜ (Eq. 4) if N≥I, and that is equal to R_{c} if N<I:

$${R}_{h} = \{ \begin{matrix}{R}_{t} , & N \geq I \\ {R}_{c} , & N < I\end{matrix} . \qquad ( Eq . 6 )$$

The third risk score computation allows for high impact events to be monitored more attentively than low impact events.

The risk scores computed according to any of the techniques above are provided to a score visualization engine 120. The score visualization engine 120 is able to produce any of various different visualizations 122 based on the risk scores 118, the impact scores 114, and the anomaly scores 110. The visualizations 122 can be displayed by a display device 124, which is part of a user console 126.

The user console 126 can include a user device such as a desktop computer, a notebook computer, a tablet computer, a smartphone, and so forth. The user console 126 can display a user interface (UI) that includes the visualizations 122. An analyst using the user console 126 can review the visualizations 122 displayed in the UI to determine whether or not anomalies are present in the computing environment.

In some examples, the different visualizations 122 can be based on the risk scores 118 computed according to respective different risk score computation techniques (such as those discussed above). For example, a first visualization 122 can be based on risk scores computed according to the first risk score computation technique, a second visualization 122 can be based on risk scores computed according to the second risk score computation technique, a third visualization 122 can be based on risk scores computed according to the third risk score computation technique, and so forth.

Each of the anomaly detector 108, impact score generator 112, risk score generator 116, and score visualization engine 120 can be implemented using a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, each of the anomaly detector 108, impact score generator 112, risk score generator 116, and score visualization engine 120 can be implemented as a combination of a hardware processing circuit and machine-readable instructions (software and/or firmware) executable on the hardware processing circuit.

In further examples, the anomaly scores 110, the impact scores 114, and/or the risk scores 118 can be provided to an anomaly detection engine 128. The anomaly detection engine 128 can use the foregoing scores to detect whether anomalies are present in the event data 104. If anomalies are detected, then the anomaly detection engine 128 can provide information identifying the detected anomalies to an anomaly resolution engine 130.

The anomaly resolution engine 130 can respond to information identifying a detected anomaly by performing a countermeasure to address the anomaly. A “countermeasure” can refer to a remedial action, or a collection of remedial actions, that can be performed to address an anomaly. Examples of countermeasures that can be performed include any of the following: causing a firewall to allow certain communications while blocking other communications, causing an intrusion detection system to detect unauthorized intrusion of a system and to disable access in response to the intrusion detection, causing a disabling system to shut down a device, cause a system to prevent communication by a device within a network, cause a device to shut down or stop or pause a program in the device, cause an anti-malware tool to scan a device or a network for identifying malware and to either remove or quarantine the malware, and so forth.

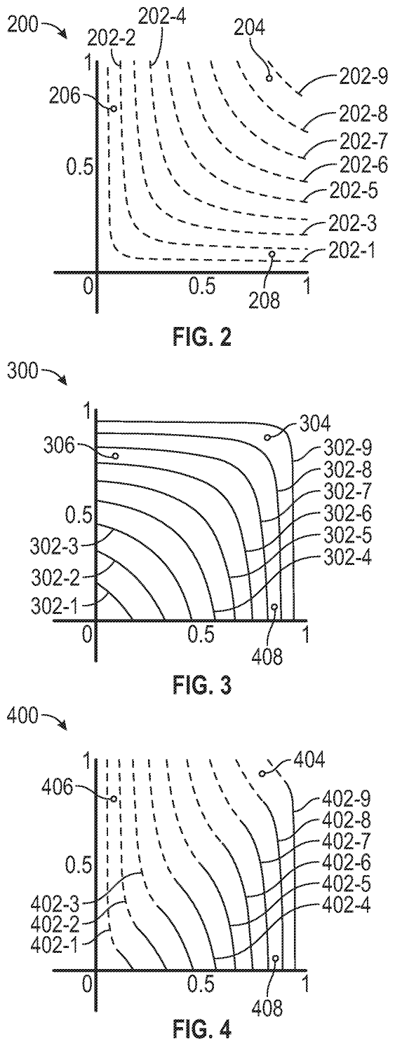

FIG. 2 illustrates an example of a visualization 122 in the form of a scatter plot 200. In the scatter plot 200, the horizontal axis represents impact scores 114, and the vertical axis represents anomaly scores 110. Each point of the scatter plot 200 represents events or entities.

The scatter plot 200 further includes iso-contour curves 202-1 to 202-9. Each iso-contour curve 202-i (i=1 to 9) includes a locus of points (representing data records) that share the same risk score. The scatter plot 200 represents risk scores computed using the first risk score computation technique (Eq. 4), in some examples.

The points along each iso-contour curve 202-i represent events or entities associated with the same risk score 118. Thus, for example, the points on the iso-contour curve 202-1 represent events or entities that correspond to a risk score of 0.1, and the points on the iso-contour curve 202-9 represents events or entities that correspond to a risk score of 0.9.

FIG. 3 illustrates an example of another visualization 122 in the form of another scatter plot 300. The scatter plot includes iso-contour curves 302-1 to 302-9 representing risk scores computed using the second risk score computation technique (Eq. 5). In an example, the points on the iso-contour curve 302-1 represent events or entities that correspond to a risk score of 0.1, and the points on the iso-contour curve 302-9 represents events or entities that correspond to a risk score of 0.9.

FIG. 4 illustrates an example of a further visualization 122 in the form of a further scatter plot 400. The scatter plot 400 includes iso-contour curves 402-1 to 402-9 representing risk scores computed using the third risk score computation technique (Eq. 6). In an example, the points on the iso-contour curve 402-1 represent events or entities that correspond to a risk score of 0.1, and the points on the iso-contour curve 402-9 represents events or entities that correspond to a risk score of 0.9.

Based on a location of a point representing an event or entity on any of the scatter plots 200, 300, and 400, an analyst can quickly determine whether the event or entity represented by the point is associated with a high risk score or a low risk score, based on the location of the point relative to the iso-contour curves depicted in a scatter plot 200, 300, or 400. For example, a point 204 in FIG. 2 is close to the iso-contour curve 202-9 that represents a risk score of 0.9. An analyst can quickly make a determination that the event or entity represented by the point 204 is associated with a high risk score. On the other hand, another point 206 in FIG. 2 is closer to the iso-contour curve 202-1 that is associated with a lower risk score of 0.1. Thus, even though the event or entity represented by the point 206 has a high anomaly score (N), the overall risk as represented by the risk score for the point 206 is low.

Another point 208 in FIG. 2 is close to the iso-contour curve 202-1 and has a high impact score, but the overall risk as represented by the risk score for the point 208 is low.

FIG. 3 shows points 304 and 306 that are generally in the same positions in the scatter plot 300 as respective points 204 and 206 in the scatter plot 200 of FIG. 2. The risk computation in FIG. 3 is more conservative (that is more risk averse) than in FIG. 2. The point 304 (for which both anomaly and impact scores are high) has about the same risk score as the point 204 in FIG. 2. However, the point 306 has a much higher risk score than the point 206, since the second risk score computation technique (Eq. 5) for the scatter plot 300 does not tolerate high anomaly or risk scores. The point 308 has a high impact score and a high risk score.

FIG. 4 is a hybrid, where you are conservative in one dimension (anomaly score) but not the other (impact score). Note that the vertical and horizontal dimensions can be swapped, depending on which of the anomaly score and impact score one is more risk averse.

In FIG. 4, point 404 has both high anomaly and impact scores, and also has a high risk score (similar to point 204 or 304). Point 406 has a high anomaly score and a low risk score (similar to 206 in FIG. 2). Point 408 has a high impact score and a high risk score (unlike point 208 in FIG. 2 but similar to point 308 in FIG. 3).

In this manner, an analyst can more readily ascertain which evidence or entities are likely anomalous events or entities. The position of the point corresponding to the event or entity provides an indication of whether or not the event or entity is a high risk event or entity.

FIGS. 5-7 show binning represented in the respective scatter plots 200, 300, and 400. Bins are defined by drawing lines starting at point (0, 0) and/or (1, 1) in the scatter plots. For example, FIG. 5 shows lines 502-1 to 502-9 from point (1, 1) to the vertical or horizontal axis of the scatter plot 200. Multiple bins are defined by the lines 502-1 to 502-9 and the iso-contour curves 202-1 to 202-9. For example, a bin 504 is defined by iso-contour curves 202-2, 202-3 and lines 502-4, 502-5. More generally, each bin is defined by a pair of adjacent iso-contour curves 202-i and 202-(i+1) and a pair of adjacent lines 502-j and 502-(j+1).

Each bin includes points representing events or entities associated with a range of risk scores, as represented by the pair of adjacent iso-contour curves 202-i and 202-(i+1), and associated with ranges of anomaly and impact scores represented by the pair of adjacent lines 502-j and 502-(j+1).

The purpose of the bins is to focus the attention of an analyst by collapsing regions with many points or those of marginal interest. If there is a single point in a bin, the point can be displayed at an exact location corresponding to the point (based on the risk score, anomaly score, and impact score of the data record represented by the point). If there are multiple points in a bin, a larger circle or other graphical element can be displayed in the bin, with the size or color or any other characteristic of the graphical element indicating a number of points represented by the graphical element.

FIG. 6 shows lines 602-1 to 602-9 from point (0, 0), that in combination with the iso-contour curves 302-1 to 302-9 define bins in the scatter plot 300.

FIG. 7 shows lines 702-1 to 702-9 from point (0, 0) or (1,1), that in combination with the iso-contour curves 402-1 to 402-9 define bins in the scatter plot 400.

In other examples, instead of using lines 502-1 to 502-9, 602-1 to 602-9, or 702-1 to 702-9, different curves can be used instead to define the bins in combination with the iso-contour curves.

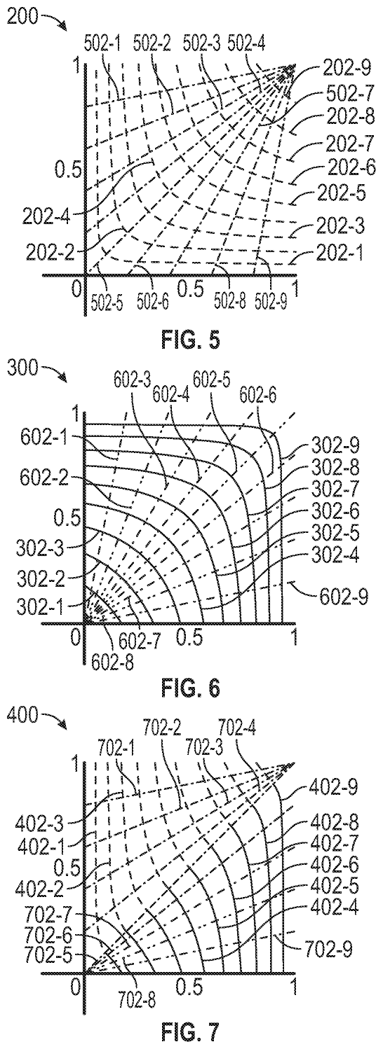

FIG. 8 is a block diagram of a non-transitory machine-readable or computer-readable storage medium 800 storing machine-readable instructions that upon execution cause a system (one computer or multiple computers) to perform respective tasks.

The machine-readable instructions include risk score computation instructions 802 to compute risk scores relating to points corresponding to events in a computing environment, using multiple different risk score computation techniques (e.g., techniques 1 to 3 discussed above).

The machine-readable instructions further include visualization generation instructions 804 to generate multiple visualizations (e.g., 122 in FIG. 1) representing the points. The generated visualizations can include the scatter plots of FIGS. 2-7, for example.

A first visualization represents the points and includes risk scores computed using a first risk score computation technique of the different risk score computation techniques, and a second visualization representing the points and including the risk scores computed using a second risk score computation technique of the different risk score computation techniques.

In some examples, the computing of a risk score includes combining an anomaly score and an impact score (such as according to Eqs. 4-6 discussed above). The computing of the risk scores includes computing, for a first point of the points a first risk score based on combining, using a first risk score computation technique, an anomaly score and an impact score for the first point, and a second risk score based on combining, using a second risk score computation technique, the anomaly score and the impact score for the first point.

For example, the first risk score is based on a product of the anomaly score and the impact score for the first point (e.g., according to Eq. 4), and the second risk score is based on a harmonic mean using the anomaly score and the impact score for the first point (e.g., according to Eq. 5).

As a further example, the first risk score is computed using a first formula responsive to a first relationship between the anomaly score and the impact score for the first point, and is computed using a second formula responsive to a second relationship between the anomaly score and the impact score for the first point (e.g., according to Eq. 6).

In additional examples, bins are defined in the first scatter plot using the iso-contour curves of the first scatter plot, where a bin of the bins in the first scatter plot includes a representation of at least one point of the points, and bins are defined in the second scatter plot using the iso-contour curves of the second scatter plot, where a bin of the bins in the second scatter plot includes a representation of at least one point of the points.

The bins in the first scatter plot are defined by further drawing curves (e.g., the lines shown in FIGS. 5-7) that intersect the iso-contour curves of the first scatter plot, and the bins in the second scatter plot are defined by further drawing curves that intersect the iso-contour curves of the second scatter plot.

In some examples, a system can receive a user selection of a first bin of the bins in the first scatter plot (such as a selection of a graphical element displayed in the first bin), and responsive to the user selection, generate a representation of points represented in the first bin.

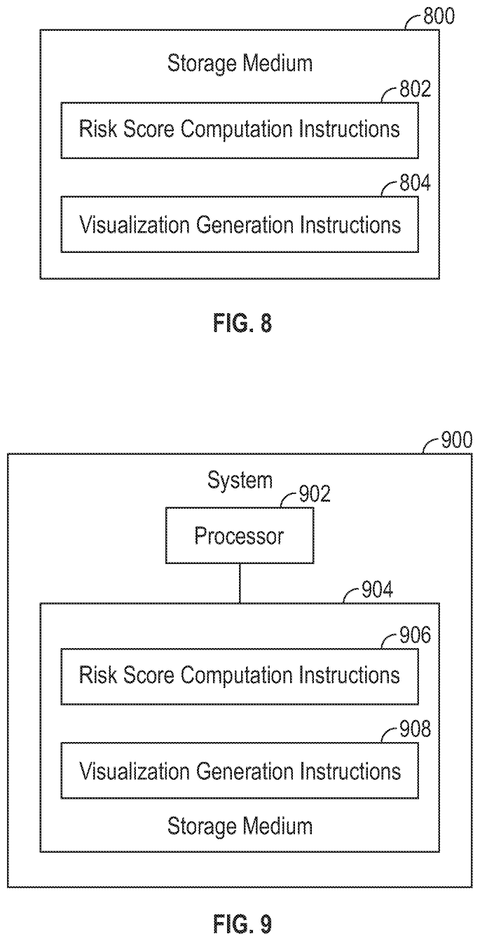

FIG. 9 is a block diagram of a system 900 including a hardware processor 902 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 900 includes a storage medium 904 storing machine-readable instructions executable on the hardware processor 902 to perform various tasks. Machine-readable instructions executable on a hardware processor can refer to the instructions executable on a single hardware processor or the instructions executable on multiple hardware processors.

The machine-readable instructions include risk score computation instructions 906 to compute risk scores relating to points corresponding to events in a computing environment, using multiple different risk score computation techniques that combine anomaly scores and impact scores in respective different ways.

The machine-readable instructions include visualization generation instructions 908 to generate multiple visualizations representing the points. The visualizations include a first visualization representing the points and including iso-contour curves representing the risk scores computed using a first risk score computation technique of the different risk score computation techniques, and a second visualization representing the points and including iso-contour curves representing the risk scores computed using a second risk score computation technique of the different risk score computation techniques.

An iso-contour curve in the first visualization represents an individual risk score, and an iso-contour curve in the second visualization represents the individual risk score, the first iso-contour curve and the second iso-contour curve having different orientations (such as the different orientations of the iso-contour curves shown in FIGS. 2-4).

In some examples, bins adjacent a lower left corner of the first visualization are smaller than bins adjacent an upper right corner of the first visualization (e.g., FIG. 5), and bins adjacent a lower left corner of the second visualization are larger than bins adjacent an upper right corner of the second visualization (e.g., FIG. 6).

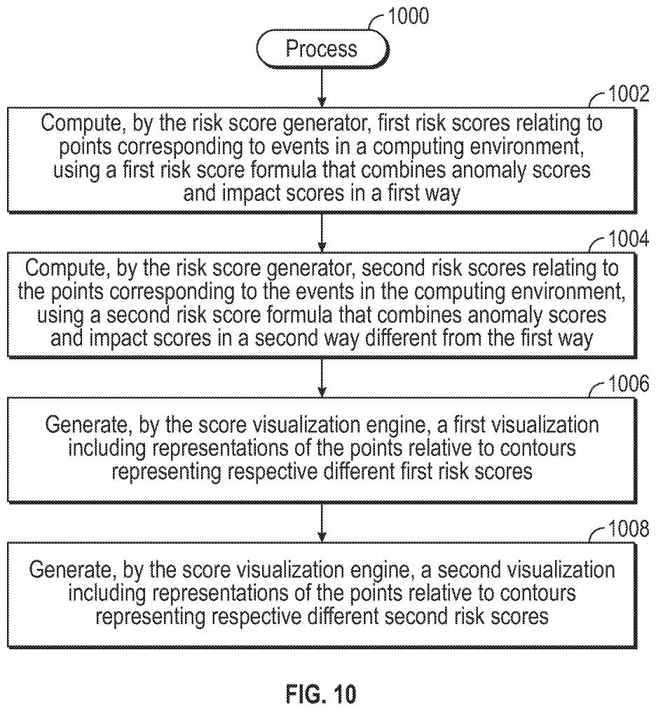

FIG. 10 is a flow diagram of a process 1000 according to some examples. The process 1000 includes computing (at 1002), by the risk score generator 116, first risk scores relating to points corresponding to events in a computing environment, using a first risk score formula that combines anomaly scores and impact scores in a first way. The process 1000 further includes computing (at 1004), by the risk score generator 116, second risk scores relating to the points corresponding to the events in the computing environment, using a second risk score formula that combines anomaly scores and impact scores in a second way different from the first way.

The process 1000 includes generating (at 1006), by the score visualization engine 120, a first visualization including representations of the points relative to contours representing respective different first risk scores.

The process 1000 further includes generating (at 1008), by the score visualization engine 120, a second visualization including representations of the points relative to contours representing respective different second risk scores.

A storage medium (e.g., 800 in FIG. 8 or 904 in FIG. 9) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
compute risk scores relating to points corresponding to events in a computing environment, using a plurality of different risk score computation techniques;
generate a plurality of visualizations representing the points, the plurality of visualizations comprising:
a first visualization representing the points and including the risk scores computed using a first risk score computation technique of the different risk score computation techniques, and
a second visualization representing the points and including the risk scores computed using a second risk score computation technique of the different risk score computation techniques.

2. The non-transitory machine-readable storage medium of claim 1, wherein the computing of a first risk score of the risk scores comprises combining an anomaly score and an impact score.

3. The non-transitory machine-readable storage medium of claim 1, wherein the computing of the risk scores comprises computing, for a first point of the points:
a first risk score based on combining, using a first risk score computation technique, an anomaly score and an impact score for the first point, and
a second risk score based on combining, using a second risk score computation technique, the anomaly score and the impact score for the first point.

4. The non-transitory machine-readable storage medium of claim 3, wherein the first risk score is based on a product of the anomaly score and the impact score for the first point, and the second risk score is based on a mean using the anomaly score and the impact score for the first point.

5. The non-transitory machine-readable storage medium of claim 4, wherein the mean using the anomaly score and the impact score for the first point comprises a harmonic mean.

6. The non-transitory machine-readable storage medium of claim 3, wherein the first risk score is computed using a first formula responsive to a first relationship between the anomaly score and the impact score for the first point, and is computed using a second formula responsive to a second relationship between the anomaly score and the impact score for the first point.

7. The non-transitory machine-readable storage medium of claim 6, wherein the first formula comprises a product of the anomaly score and the impact score for the first point, and the second formula comprises a mean using the anomaly score and the impact score for the first point.

8. The non-transitory machine-readable storage medium of claim 2, wherein the first visualization comprises a first scatter plot relating anomaly scores to impact scores, and the second visualization comprises a second scatter plot relating anomaly scores to impact scores.

9. The non-transitory machine-readable storage medium of claim 8, wherein the first scatter plot comprises iso-contour curves corresponding to respective risk scores, and the second visualization comprises a second scatter plot relating anomaly scores to impact scores, wherein each iso-contour curve of the iso-contour curves in the first and second scatter plots represent a respective same risk score.

10. The non-transitory machine-readable storage medium of claim 9, wherein the instructions upon execution cause the system to:
define bins in the first scatter plot using the iso-contour curves of the first scatter plot, wherein a bin of the bins in the first scatter plot comprises a representation of at least one point of the points; and
define bins in the second scatter plot using the iso-contour curves of the second scatter plot, wherein a bin of the bins in the second scatter plot comprises a representation of at least one point of the points.

11. The non-transitory machine-readable storage medium of claim 10, wherein each bin of the bins in the first scatter plot represents a respective range of risk scores, and each bin of the bins in the second scatter plot represents a respective range of risk scores.

12. The non-transitory machine-readable storage medium of claim 10, wherein the bins in the first scatter plot are defined by further drawing curves that intersect the iso-contour curves of the first scatter plot, and the bins in the second scatter plot are defined by further drawing curves that intersect the iso-contour curves of the second scatter plot.

13. The non-transitory machine-readable storage medium of claim 10, wherein the instructions upon execution cause the system to:
receive a user selection of a first bin of the bins in the first scatter plot; and
responsive to the user selection, generate a representation of points represented in the first bin.

14. The non-transitory machine-readable storage medium of claim 10, wherein bins in a first part of the first scatter plot are larger than bins in a second part of the first scatter plot.

15. A system comprising:
a processor; and
a non-transitory storage medium storing instructions executable on the processor to:
compute risk scores relating to points corresponding to events in a computing environment, using a plurality of different risk score computation techniques that combine anomaly scores and impact scores in respective different ways;
generate a plurality of visualizations representing the points, the plurality of visualizations comprising:
a first visualization representing the points and including contours representing the risk scores computed using a first risk score computation technique of the different risk score computation techniques and
a second visualization representing the points and including contours representing the risk scores computed using a second risk score computation technique of the different risk score computation techniques.

16. The system of claim 15, wherein a contour of the contours in the first visualization comprises a first iso-contour that represents an individual risk score, and a contour of the contours in the second visualization comprises a second iso-contour that represents the individual risk score, the first iso-contour and the second iso-contour having different orientations.

17. The system of claim 16, wherein the instructions are executable on the processor to:
draw curves in the first visualization to provide bins with boundaries defined by the curves in the first visualization and the contours in the first visualization; and
draw curves in the second visualization to provide bins with boundaries defined by the curves in the second visualization and the contours in the second visualization.

18. The system of claim 17, wherein bins adjacent a lower left corner of the first visualization are smaller than bins adjacent an upper right corner of the first visualization, and wherein bins adjacent a lower left corner of the second visualization are larger than bins adjacent an upper right corner of the second visualization.

19. A method performed by a system comprising a hardware processor, comprising:
computing first risk scores relating to points corresponding to events in a computing environment, using a first risk score formula that combines anomaly scores and impact scores in a first way;
computing second risk scores relating to the points corresponding to the events in the computing environment, using a second risk score formula that combines anomaly scores and impact scores in a second way different from the first way;
generating a first visualization including representations of the points relative to contours representing respective different first risk scores; and
generating a second visualization including representations of the points relative to contours representing respective different second risk scores.

20. The method of claim 19, further comprising:
computing third risk scores relating to the points corresponding to the events in the computing environment, using a third risk score formula that combines anomaly scores and impact scores in a third way different from the first way and the second way; and
generating a third visualization including representations of the points relative to contours representing respective different third risk scores.
